(19) United States
(12) Patent Application Publication
(10) Pub. No.: US 2011/0090410 A1
(43) Pub. Date: Apr. 21, 2011

(54) DISPLAY SUPPORTING BRACKET AND DISPLAY USING SAME

(75) Inventor: ZHEN-XING YE, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/764,986

(22) Filed: Apr. 22, 2010

(30) Foreign Application Priority Data
Oct. 20, 2009 (CN) 200910308477.5

(51) Int. Cl. H04N 5/64; F16M 11/04

(52) U.S. Cl. 348/836; 248/125.8; 348/E05.128

(57) ABSTRACT

The display supporting bracket includes a base, a telescopic rod, a movable support, a clip, a connecting means and a frame. The telescopic rod is telescopic mounted on the base and can be moved upward or downward relative to the base. The movable support is slidably mounted on the telescopic rod. The clip is pivotally mounted on the support. The frame is rotatably mounted on the clip by the connecting means for supporting a display thereon.

### BACKGROUND

1. Technical Field

The disclosure relates to a display support bracket, and especially to a support bracket for supporting flat plate display.

2. Description of Related Art

Flat plate displays, such as popular liquid crystal displays, are commonly supported by a support that is set on a table or disk and has an adjustable height and view angle within a limited or narrow range. However, for displaying some special programs such as videos, presentations, or web/net pages, the flat plate displays need to be adjusted in a wider range for comfortable viewing. Doing this for the most part is very inconvenient with a conventional support.

Therefore it is desirable to provide a display supporting bracket to overcome the aforementioned limitations.

### BRIEF DESCRIPTION OF THE DRAWINGS

FIG. 1 is an isometric view of a display supporting bracket in accordance with one embodiment.

FIG. 2 is an isometric view of the display supporting bracket of FIG. 1 in a use status.

### DETAILED DESCRIPTION

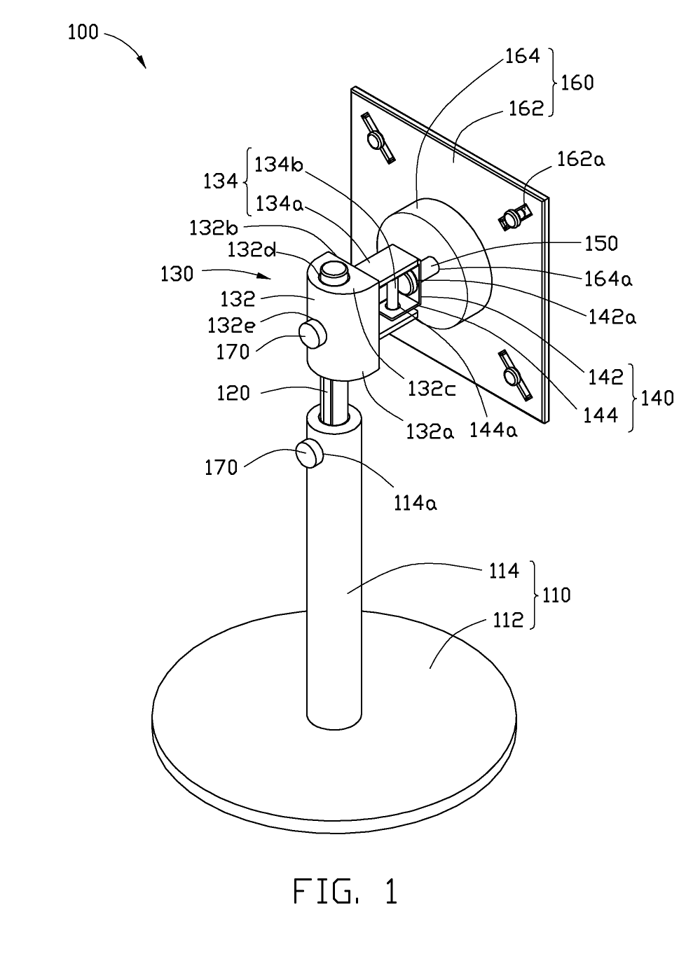

Referring to FIG. 1, a display supporting bracket 100 in accordance with an exemplary embodiment of present disclosure is shown. The display supporting bracket 100 includes a base 110, a telescopic rod 120, a movable support 130, a clip 140, a connecting means 150, a frame 160 and a number of fastening members 170. The telescopic rod 120 is telescopically mounted on the base 110. The telescopic rod 120 can be moved upward or downward relative to the base 100 and can be fixed at any position of the base 110 with one of the fastening members 170. The movable support 130 is slidably mounted on the telescopic rod 120. The movable support 130 can be moved along the telescopic rod 120 and can be fixed at any position of the telescopic rod 120 with one of the fastening members 170. The clip 140 is pivotally mounted on the support 130. The frame 160 is rotatably mounted on the clip 140 by the connecting means 150 for supporting a display thereon.

The base 110 includes a chassis 112, and a hollow pole 114. The pole 114 is perpendicularly mounted on the chassis 112 and one end of the telescopic rod 120 is received in the pole 114. A threaded hole 114a is defined in the pole 114 throughout a wall of the pole 114 and communicates with the inner space of the pole 114 for allowing the fastening member 170 to pass through to press against the telescopic rod 120, thus to fix and position the telescopic rod 120 in the pole 114.

The support 130 is slidably mounted on an exposed end of the telescopic rod 120. The support 130 includes a slide block 132 and a holder 134 consisting of two parallel plates 134a perpendicularly extending from a side surface of the slide block 132, and a connection pin 134b perpendicularly connecting the plates 134a. The slide block 132 includes a cylindrical surface 132a, a side surface 132b opposite to the cylindrical surface 132a, and two end surfaces 132c interconnecting the cylindrical surface 132a and the side surface 132b. A through hole 132d is defined in the slide block 132 spanning the end surfaces 132c. A thread hole 132e is defined in the slide block 132 from the cylindrical surface 132a to reach and communicate with the through hole 132d. The plates 134a are perpendicularly mounted on the side surface 132b of the slide block 132. The support 130 is sleeved on the telescopic rod 120 through the through hole 132d. One of the fastening members 170 passes through the thread hole 132e and presses against the telescopic rod 120 to fix and position the support 130 on the telescopic rod 120.

The clip 140 is U-shaped including a connection plate 142 and two overhanging arms 144 perpendicularly connected to opposite ends of the connection plate 142. A first hole 142a is defined in the middle of the connection plate 142 for allowing the connecting means 150 such as a bolt to pass through and pivotally connect the frame 160 to the clip 140. Two second holes 144a are respectively defined in the overhanging arms 144 and aligned with each other. The clip 140 is pivotally mounted on the connection pin 134b through the second holds 144a of the overhanging arms 144.

The frame 160 includes a hold plate 162 and a circular bump 164 formed on the back of the hold plate 162. The hold plate 162 is rectangular and defines four symmetry slots 162a at the corners of the hold plate 162. The slots 162a are provided for several of the fastening members 170 to pass through to fasten a display on the frame 160. A threaded hole 164a is defined at the center of the bump 164 for mating with the connecting means 150 thereby pivotally connecting the frame 160 to the clips 140.

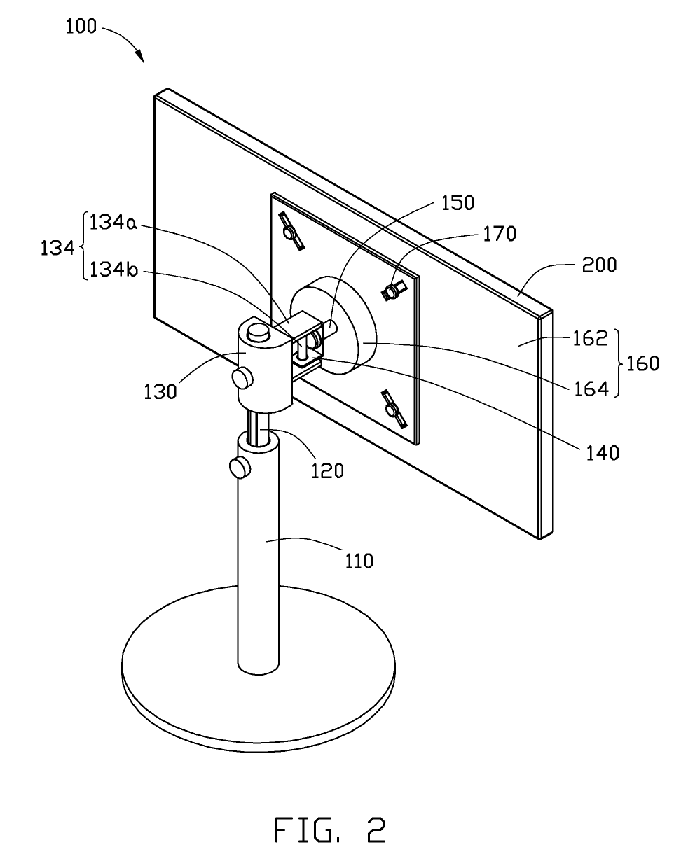

Referring to FIG. 2, a display panel 200 is fixed to the frame 160 with four fastening members 170. In present disclosure, the telescopic rod 120 and the connection pin 134b of the display supporting bracket 100 serve as two parallel pivotal shafts, which ensure the display 200 is capable of being rotated at any desired angle in the horizontal plane. The connecting means 150 serves as another pivotal shaft that ensures that the display panel 200 is capable of being rotated at any desired angle in a vertical plane perpendicular to the horizontal plane. The height of the display panel 200 relative to the base 110 can be changed by moving the telescopic rod 120 relative to the pole 114 of the base or by moving the slide block 132 of the support 130 relative to the telescopic rod 120. Accordingly, the display supporting bracket 100 is capable of providing a convenient operation and position change of the display and a wider range for allowing a wider range of positions of the display.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A display supporting bracket comprising:
a base;
a telescopic rod mounted on the base and capable of being moved upward or downward relative to the base;
a movable support slidably mounted on the telescopic rod;
a clip pivotally mounted on the support;
connecting means; and
a frame rotatably mounted on the clip by the connecting means for supporting a display thereon.

2. The display supporting bracket of claim 1 further comprising a plurality of fastening members; wherein the telescopic rod is mounted on the base with one of the fastening members; and the movable support is slidably mounted on the telescopic rod by another one of the fastening members.

3. The display supporting bracket of claim 2, wherein the base comprises a chassis, and a cylindrical hollow pole, the telescopic rod is received in the hollow pole; the pole is perpendicularly mounted at the center of the chassis and defines a threaded hole throughout the wall thereof and communicates with the inner space of the pole; the one of the fastening member passes through the threaded hole to press against and fix the telescopic rod in the cylindrical hollow pole.

4. The display supporting bracket of claim 3, wherein support comprises a slide block and a holder connected on the slide block; the slide block is slidably mounted on an exposed end of the telescopic rod; the clip is pivotally connected on the holder.

5. The display supporting bracket of claim 4, wherein the slide block comprises a cylindrical surface, a side surface opposite to the cylindrical surface, and two end surfaces interconnecting the cylindrical surface and the side surface; the slide block defines a through hole spanning the end surfaces and a thread hole from the cylindrical surface to reach and communicate with the through hole; the support is sleeved on the telescopic rod through the through hole; the another one of the fastening member passes through the thread hole and presses against the telescopic rod to fix the support on the telescopic rod.

6. The display supporting bracket of claim 5, wherein the holder comprises two parallel plates perpendicularly mounted on the side surface of the slide block, and a connection pin perpendicularly connecting the plates; the clip is pivotally connected to the connection pin of the holder.

7. The display supporting bracket of claim 6, wherein the clip comprises a connection plate and two overhanging arms perpendicularly connected to opposite end of the connection plate; the connection plate defines a first hole for the blot passing through and pivotally connecting the frame to the clip; the overhanging arms respectively defines a second holes which are aligned with each other; the clip is pivotally mounted on the connection pin through the second holes of the overhung arms.

8. The display supporting bracket of claim 7, wherein the frame comprises a hold plate and a circular bump formed on the back of the hold plate; the connecting means is a bolt and the bump defines a threaded hole for mating with the bolt thereby pivotally connecting the frame and the clips.

9. The display supporting bracket of claim 8, wherein the hold plate is rectangular and defines four symmetry slots at the corner portions of the hold plate for fastening members to pass through to fasten the display on the frame.

10. A display comprising:
display supporting bracket comprising:
a base;
a telescopic rod mounted on the base and capable of being moved upward or downward relative to the base;
a movable support slidably mounted on the telescopic rod;
a clip pivotally mounted on the support;
connecting means; and
a frame rotatably mounted on the clip by the connecting means; and
a display panel fixed to the frame.

11. The display of claim 10, where in the display supporting bracket further comprises a plurality of fastening members; the telescopic rod is mounted on the base with one of the fastening members; and the movable support is slidably mounted on the telescopic rod by another one of the fastening members; the display panel is fixed to the frame by portions of the fastening members.

12. The display of claim 11, wherein the base comprises a chassis, and a cylindrical hollow pole, the telescopic rod is received in the hollow pole; the pole is perpendicularly mounted at the center of the chassis and defines a threaded hole throughout the wall thereof and communicates with the inner space of the pole; the one of the fastening member passes through the threaded hole to press against and fix the telescopic rod in the cylindrical hollow pole.

13. The display of claim 12, wherein support comprises a slide block and a holder connected on the slide block; the slide block is slidably mounted on an exposed end of the telescopic rod; the clip is pivotally connected on the holder.

14. The display of claim 13, wherein the slide block comprises a cylindrical surface, a side surface opposite to the cylindrical surface, and two end surfaces interconnecting the cylindrical surface and the side surface; the slide block defines a through hole spanning the end surfaces and a thread hole from the cylindrical surface to reach and communicate with the through hole; the support is sleeved on the telescopic rod through the through hole; the another one of the fastening member passes through the thread hole and presses against the telescopic rod to fix the support on the telescopic rod.

15. The display of claim 14, wherein the holder comprises two parallel plates perpendicularly mounted on the side surface of the slide block, and a connection pin perpendicularly connecting the plates; the clip is pivotally connected to the connection pin of the holder.

16. The display of claim 15, wherein the clip comprises a connection plate and two overhanging arms perpendicularly connected to opposite end of the connection plate;
the connection plate defines a first hole for the blot passing through and pivotally connecting the frame to the clip; the overhanging arms respectively defines a second holes which are aligned with each other; the clip is pivotally mounted on the connection pin through the second holes of the overhung arms.

17. The display of claim 16, wherein the frame comprises a hold plate and a circular bump formed on the back of the hold plate; the connecting means is a bolt and the bump defines a threaded hole for mating with the bolt thereby pivotally connecting the frame and the clips.

18. The display of claim 17, wherein the hold plate is rectangular and defines four symmetry slots at the corner portions of the hold plate for fastening members to pass through to fasten the display on the frame.
